(19) United States
(12) Patent Application Publication
(10) Pub. No.: US 2009/0248209 A1
(43) Pub. Date: Oct. 1, 2009

(54) Apparatus for reduction of vibrations of a structure

(75) Inventors: Elmar BREITBACH, Gottingen (DE); Stefan HOMANN, Hamburg (DE); Tom WEYER, Braunschweig (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DEUTSCHES ZENTRUM FUR LUFT- UND RAUMFAHRT E.V., Koln (DE)

(21) Appl. No.: 12/412,505

(22) Filed: Mar. 27, 2009

Related U.S. Application Data
(63) Continuation of application No. PCT/EP2007/008460, filed on Sep. 28, 2007.

(30) Foreign Application Priority Data
Sep. 30, 2006 (DE) 10 2006 046 593.8

(51) Int. Cl. G05B 13/02

(52) U.S. Cl. 700/280

(57) ABSTRACT

An apparatus (7) for reduction of vibrations of a structure (1) has a vibration sensor (8) which is arranged in a structure (1), an actuator (11) which acts on the structure, and a control system (9) which drives the actuator (11) as a function of a signal (10) from the vibration sensor (8). The control system (9) itself has an electrical resonant circuit (14), which defines the profile of a transfer function of the control system (9) between the signal (10) from the vibration sensor (8) and the drive (12) of the actuator (11).

### CROSS-REFERENCE TO RELATED APPLICATIONS

This application is a continuation of international patent application PCT/EP2007/008460, which is entitled “Device for Reducing the Vibrations of a Structure” which was filed on Sep. 28, 2007 and claims the priority of the German patent application No. DE 10 2006 046 593.8, which is entitled “Apparatus for reduction of vibrations of a structure” which was filed on Sep. 30, 2006 and is pending in parallel.

### FIELD OF THE INVENTION

The invention relates to an apparatus for reduction of vibrations of a structure. The present invention relates in particular to an apparatus such as this for reduction of vibrations of a structure having an actuator which acts on the structure and having a control system which drives the actuator as a function of a signal from the vibration sensor and has an electrical resonant circuit, which defines the profile of a transfer function of the control system between the signal from the vibration sensor and the drive of the actuator.

### BACKGROUND TO THE INVENTION

The use of so-called passive vibration absorbers is known in order to reduce vibrations of a structure. The vibration absorbers have a mechanical structure with an absorber mass, which is elastically coupled via an absorber stiffness, that is to say a spring, to the structure whose vibrations are to be reduced. The vibrations of the structure excite the absorber mass to oscillate, because of the coupling between them. If the natural frequencies of the structure and of the vibration absorber are identical, the reaction forces which are exerted by the vibration absorber on the structure result in the structure being kept at rest by the vibration absorber, at the natural frequency of the structure. This ideal effect of a vibration absorber occurs, however, exclusively in the situation in which the absorber natural frequency is equal to the frequency of the structure vibrations to be reduced. If, in contrast, the structure has a plurality of natural frequencies or has at least one variable natural frequency, or is caused to oscillate by a variable-frequency, external, periodic force, conventional, purely passive vibration absorbers quickly reach their limits. If natural frequencies of the structure are intended to be influenced in order to reduce vibration, a plurality of vibration absorbers must be provided, in which case the greater number of absorbers which results from this results in an undesirable increase in the total mass of the system. In addition, variable-frequency excitation of the structure can be counteracted by a plurality of vibration absorbers only when the frequency bandwidth remains narrow.

It is known that the useable frequency range around the actual absorber natural frequency of a passive vibration absorber can be broadened in the frequency domain by damping the movements of the absorber mass. However, the introduction of damping reduces the capability of a passive vibration absorber to keep the structure at rest at the absorber natural frequency. All that can then be achieved is to reduce the vibrations of the structure at the absorber natural frequency. However, a vibration absorber with integrated damping then carries out this function over a wider frequency range. The greater the damping, the less the extent to which the structure is kept ideally at rest at the absorber natural frequency, but, in addition, the broader the frequency range in which the vibration absorber reduces vibrations of the structure to an extent which is still useful.

Various experiments have been carried out in order to make the absorber natural frequency of a vibration absorber variable, in order to allow this absorber natural frequency to be tuned to the frequency of structure vibrations which are currently particularly disturbing. One example of this is described in DE 103 51 243 A1. Even if, as here, the absorber natural frequency is varied quite effectively in comparison with the actuator complexity accepted for this purpose, the complexity for a tunable-frequency vibration absorber such as this is relatively high compared with the frequency range which can be covered by its variable absorber natural frequency.

A further approach for broadening the frequency range over which a fundamentally passive vibration absorber is suitable for reduction of vibrations of a structure is known from DE 197 25 770 A1. In this case, a linear actuator is arranged between the absorber stiffness and the structure, in order to additionally actively excite the vibration absorber at frequencies alongside the absorber natural frequency, by driving the linear actuator. The purpose of this is to actively increase the amplitude of the vibrations of the absorber mass at these frequencies to such an extent that the forces which are fed back from the vibration absorber into the structure are also effectively able to reduce vibrations of the structure at these frequencies. As in the case of all active measures for reduction of vibrations of a structure, it is also necessary in this case for the linear actuator to be driven in the correct phase. Finally, the complexity that needs to be accepted is also relatively high in this case, compared with the achieved broadening of the useable frequency range of the vibration absorber.

All vibration absorbers with a mechanical design are associated with the disadvantage that their absorber mass must be tuned to the vibration energy of the vibrations to be reduced in order that the distances which have to be moved over by the absorber mass in order to provide the necessary feedback forces to the structure remain within limits. On the one hand, this is necessary because actual absorber stiffnesses are suitable only for limited distances and, on the other hand, because the physical space occupied by a vibration absorber also increases as the movement distance of the absorber mass increases. In practice this means that, for example, the mass of the vibration absorber which is installed overall in a propeller-driven aircraft whose structure is solid at the frequency of revolution of the propeller and in this case is excited at harmonics makes up a quite considerable proportion of the total mass of the propeller-driven aircraft.

The principle of active vibration reduction is known for the specific field of paper coating apparatuses from EP 0 956 950 A1, in which acceleration forces which act on a structure have superimposed on them, for cancellation purposes, forces of the same magnitude but in the opposite sense, which are caused by actively driven actuators. The desired cancellation is in this case dependent on the forces which are produced by the actuators not only being of the correct magnitude but also being in the correct phase, that is to say the opposite phase, with respect to the structure excitations to be suppressed. For this reason an apparatus which is known from DE 197 25 770 A1 and has the features of the type described initially has, in addition to the actuator which acts on the structure, an acceleration sensor which is arranged on the structure. A control system of the known apparatus drives the actuator as a function of the signal from the acceleration sensor such that the actuator holds the structure at rest by means of the forces produced by it. In principle, this procedure is independent of frequency, that is to say an apparatus such as this can be effective over a very wide frequency range. However, in practice, the consideration of undefined frequencies for driving the actuator results in considerable difficulties. DE 197 25 770 A1 therefore discloses detection of the rotational frequency of the rotating structure which is equipped with an active vibration reduction, and restriction of the actuator drive to this rotational frequency and harmonics of it. The principle of active vibration reduction of a structure can also be described by providing the structure with an “infinite” stiffness with the aid of the actuator drive, with respect to the vibrations detected by the vibration sensor. The amount of energy that needs to be accepted for this principle for driving the actuator which acts on the structure is, however, quite considerable when the structure is excited to a relatively major extent. The advantages over passive vibration absorbers are therefore limited and, furthermore, passive vibration absorbers are considerably more reliable than the complex control system which is required for active vibration reduction.

An apparatus which is known from EP 1 291 551 for reduction of vibrations of a structure uses a passive electrical resonant circuit which is linked to the structure via a piezo-element, which is used as a sensor, and an actuator that is separate from the sensor, with this structure being that whose vibrations are intended to be reduced. The sensor converts mechanical energy of the structure to electrical energy, by which means the sensor generates a voltage signal. The voltage signal is supplied to the passive electrical resonant circuit. When the voltage is at a frequency equal to or close to the natural frequency of the passive electrical resonant circuit, this resonant circuit oscillates. The electrical resonant circuit applies an opposing voltage to the actuator, which deforms it such that it counteracts the vibration of the structure. This type of coupling of the sensor and of the actuator to the electrical resonant circuit in conjunction with the electrical resonant circuit being formed from a resistor, an inductance and/or a capacitance admittedly results in the same disadvantage of the vibration damping being restricted to a narrow frequency range, as in the case of a passive mechanical vibration absorber, whose maximum efficiency is, however, not achieved at the absorber natural frequency.

In the case of an apparatus, for reduction of vibrations of a structure as known from DE 103 55 624 A1, a piezo-element is provided, which is applied to the structure and is provided with a control circuit in an electrical circuit. The control circuit is configured to feed energy back from the piezo-element with a phase-shift with respect to the vibration. In this case, the control circuit for phase shifting is integrated in the electrical circuit which, with the piezo-element, forms a resonant circuit, and has an operational amplifier which is powered via an auxiliary energy source. It is therefore possible to feed back into the piezo-element the electrical energy which is produced in the piezo-element as a consequence of mechanical vibration, with a phase-shift with respect to the vibration, such that a force which counteracts the mechanical vibrations and reduces the vibration is produced by making use of the reciprocal piezoelectric effect. Once again, this is subject to the disadvantages of the functional restriction to a single natural frequency of the resonant circuit that is formed with an inductance and a capacitance, without being able to achieve the particular advantages of a mechanical vibration absorber in terms of its maximum efficiency at the absorber natural frequency.

There is also a requirement for an apparatus for reduction of vibrations of a structure in which the control system for driving the actuator is designed in as simple a manner as possible in order as far as possible to overcome the disadvantages which have existed until now of active vibration reduction in comparison to a passive vibration absorber, without losing the fundamental frequency variability of active vibration reduction.

### SUMMARY OF THE INVENTION

In one aspect, the invention provides an apparatus for reduction of vibrations of a structure, having a vibration sensor which is arranged on the structure and emits a signal which describes the vibrations, an actuator which acts on the structure, and a control system which drives the actuator as a function of the signal from the vibration sensor and has an electrical resonant circuit with a natural frequency, in which resonant circuit a voltage signal is fed back and which resonant circuit defines a transfer function of the control system between the signal from the vibration sensor and the drive of the actuator, wherein the control system generates a distance-proportional voltage signal from the signal from the vibration sensor, which voltage signal is proportional to deflections of the structure resulting from the vibrations, and injects this voltage signal into the resonant circuit and wherein the control system drives the actuator with a difference between the fed-back voltage signal from the electrical resonant circuit and the distance-proportional voltage signal.

In a more specific aspect, the invention provides an apparatus having a vibration sensor which is arranged on the structure and emits a signal which describes the vibrations, an actuator which acts on the structure, and a control system, which drives the actuator as a function of the signal from the vibration sensor and has an electrical resonant circuit, which is formed from operational amplifiers and has one natural frequency, in which resonant circuit a voltage signal is fed back, and which resonant circuit defines a transfer function of the control system between the signal from the vibration sensor and the drive of the actuator, wherein the control system generates a distance-proportional voltage signal from the signal from the vibration sensor, which voltage signal is proportional to deflections of the structure resulting from the vibrations, and injects the voltage signal into the resonant circuit and wherein the control system drives a power amplifier for driving the actuator with a difference between the fed-back voltage signal from the electrical resonant circuit and the distance-proportional voltage signal.

In the novel apparatus, the control system has an electrical resonant circuit which is designed analogously to a mechanical absorber and defines the profile of a transfer function of the control system between the signal from the vibration sensor and the drive for the actuator. This does not mean that, somewhere, the control system according to the invention has some type of electrical resonant circuit, as may also already be the case in a control system for an apparatus from the prior art. In fact this relates to the profile of the transfer function of the control system between the signal from the vibration sensor and the drive of the actuator, that is to say the response of the control system, being defined in the form of a drive of the actuator in response to the signal from the vibration sensor, in terms of magnitude and phase, via the electrical resonant circuit. The present invention is based on the concept of replacing the mechanical resonant circuit of a passive vibration absorber by an analogously designed electrical resonant circuit and of using the vibration sensor on the one hand and the actuator on the other hand to simulate in analog form the relevant couplings of a mechanical vibration absorber to the structure whose vibrations are intended to be reduced. Except for adaptations between the electrical resonant circuit and the mechanical structure, which may require electrical power to be supplied, the novel apparatus acts passively like a mechanical vibration absorber to the extent that the response to vibrations of the structure is defined by the passive electrical resonant circuit and at least a portion of the power which is required to reduce the vibrations of the structure is available as volt-amperes reactive. This guarantees that the novel apparatus is highly reliable and can be operated in an energy-saving manner. The matching of the electrical resonant circuit to the energy of the structure vibrations to be reduced can be carried out by designing the electrical resonant circuit to be larger, that is to say by using larger electrical components. In this case, adaptation between the electrical resonant circuit and the mechanical structure is achieved with a small amount of externally supplied electrical power. However, in principle, it is also sufficient to provide matching to the energy of the vibrations to be reduced in the region of the interface between the electrical resonant circuit and the mechanical structure.

In the novel apparatus, the resonant circuit is formed from operational amplifiers. At least two operational amplifiers are provided. There are preferably at least three operational amplifiers. A first of the operational amplifiers is used as a differential amplifier and each of the others is used as an integrator for the output signal from the preceding operational amplifier, and the output signal from at least the last integrator in the series is fed back to the differential amplifier.

In principle, the electrical resonant circuit of the novel apparatus has a fixed natural frequency. However, it is possible without any difficulty to make changes to this electrical resonant circuit, for example by varying its electrical parameters, in order to vary its natural frequency. This natural frequency can therefore easily be tuned or readjusted to a relevant frequency component of the vibrations of the structure. The capability to easily vary the electrical parameters of the electrical resonant circuit means that it is possible to vary not only its natural frequency but also, to the extent that this is desirable, its damping, for example, and to optimize these parameters with respect to the current operating conditions of the apparatus.

The tuning of the natural frequency and, possibly, also the damping of the electrical resonant circuit by variation of its electrical parameters are preferably carried out as a function of a dominant frequency component of the signal from the vibration sensor or from a further sensor. It is also possible to use a plurality of further sensors for determining the currently ideal electrical parameters of the electrical resonant circuit.

In order to use the vibration sensor to simulate the coupling of a mechanical vibration absorber to the structure, the control system uses the signal from the vibration sensor to generate a distance-proportional voltage signal, which is fed back to the resonant circuit. A distance-proportional voltage signal is provided directly by a distance sensor. However, it may also be generated by single integration or double integration from the signal from a velocity sensor or from an acceleration sensor. In principle, it is also possible for a voltage signal which is proportional to the velocity or acceleration to be fed back directly to the resonant circuit in the novel control system.

In order to simulate the coupling of the mechanical structure to a mechanical vibration absorber, the control system drives the actuator with a difference between a fed-back voltage signal from the electrical resonant circuit and the distance-proportional voltage signal tapped off on the mechanical structure. This drive is typically provided by means of a power amplifier. The fed-back voltage signal from the electrical resonant circuit corresponds to the vibration movement distance of the absorber mass which, depending on its position with respect to the structure, acts on the structure via the absorber stiffness which is simulated in the electrical resonant circuit.

The electrical resonant circuit of the control system for the novel apparatus may be provided in analog form or may be simulated digitally. Specifically, the electrical resonant circuit may be formed from integrated circuits, in which case matching to the power level of the mechanical structure may be more complex. Conversely, a digitally simulated electrical resonant circuit makes it easier to vary the electrical parameters of the resonant circuit in order to vary its natural frequency and/or damping as required.

The actuator by means of which the control system acts on the mechanical structure is preferably an actuator which is supported exclusively on the structure itself, that is to say it acts at least two points on the structure and is effective between them. Position changes of the structure with respect to an external support of the actuator can then be ignored.

Specifically, the actuator may have a layer structure comprising two flat electrodes and a piezoelectric layer which is arranged between the flat electrodes and extends between the flat electrodes, on their main extent plane, when a voltage is applied. In consequence, a flat element of the structure to which this actuator is connected over an area is subject to a bending load. This makes it possible to very effectively counteract frequently occurring bending vibrations of a wall or of some other flat element of a structure.

As has already been indicated a number of times, the natural frequency of the electrical resonant circuit of the novel apparatus can be varied easily. The electrical resonant circuit may, however, also be designed without any problems such that it has a plurality of natural frequencies and therefore ideally defines the response, that is to say the transfer function, of the control system to vibrations of the mechanical structure at a plurality of frequencies.

Advantageous developments of the invention are specified in the patent claims, the description and the drawings. The advantages, as stated in the introductory part of the description, of features and of combinations of features are only by way of example and may be used alternatively or cumulatively without the advantages necessarily having to be achieved by embodiments according to the invention. Further features are specified in the drawings—in particular the illustrated geometries and the relative dimensions of a plurality of components with respect to one another, as well as their relative arrangement and operative connection. The combination of features of different embodiments of the invention or of features of different patent claims is likewise possible in a different manner from the selected back-references in the patent claims, and is hereby suggested. This also relates to those features which are illustrated in separate drawings or are mentioned in the description of the drawings. These features can also be combined with the features of different patent claims. Features stated in the patent claims can likewise be omitted for further embodiments of the invention.

### BRIEF DESCRIPTION OF THE FIGURES

The invention will be explained and described in more detail in the following text using exemplary embodiments and with reference to the attached drawings.

FIG. 1 shows a block diagram of an elastic structure with a mechanical vibration absorber fitted to it.

FIG. 2 shows a block diagram of a first embodiment of the present invention, in which the mechanical vibration absorber shown in FIG. 1 is simulated by an electrical resonant circuit.

FIG. 3 shows a block diagram which, in comparison to FIG. 1, has had added to it damping of the absorber mass of the mechanical vibration absorber.

FIG. 4 shows the block diagram of a second embodiment of the present invention, which simulates the mechanical vibration absorber with damping illustrated in FIG. 3, and in which further extension options in comparison to FIG. 2, are indicated.

FIG. 5 shows the arrangement of an actuator on a structure for use of the novel apparatus; and

FIG. 6 shows details of the actuator shown in FIG. 5.

### DETAILED DESCRIPTION

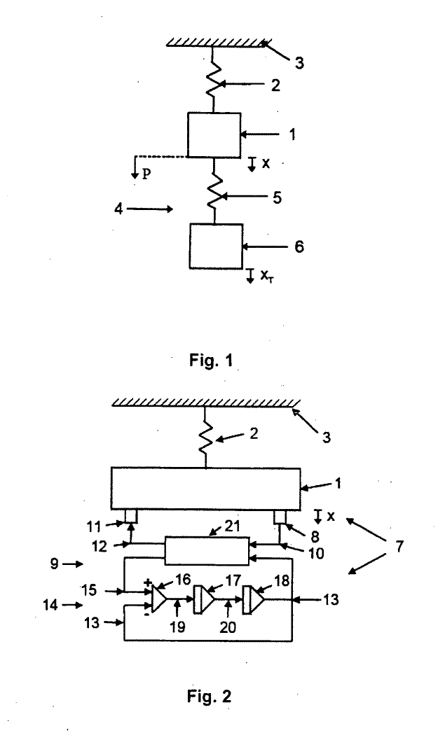

FIG. 1 shows a mechanical structure 1 which is illustrated here in such a way that it is coupled via structure stiffness 2 to a fixed-position base 3, in order to reproduce its elasticity. A mechanical vibration absorber 4 comprising an absorber stiffness 5 and an absorber mass 6 is coupled to the structure 1, with the absorber stiffness 5 linking the absorber mass 6 to the structure 1. If the absorber natural frequency of the vibration absorber 4 is equal to the natural frequency of the structure 1, such that the following equation (0) is applicable:

$${ω}^{2} = \frac{{c}_{T}}{{m}_{T}} = \frac{K}{M} \qquad ( 0 )$$

where ω is the corresponding natural frequency expressed as an angular frequency, c_{T} is the value of the absorber stiffness 5, m_{T} is the value of the absorber mass 6, K is the value of the modal structure stiffness 2 and M is the value of the modal mass of the structure 1, the vibration absorber 4 reduces vibrations of the structure 1 at the corresponding natural frequency to zero.

Equation (1) is applicable to the total force P acting on the modal mass of the structure 1 in the system as shown in FIG. 1:

M\dot{x}+Kx+c_{T}(x−x_{T})=P (1),

where x is the displacement of the structure 1, x_{T} is the displacement of the absorber mass 6, and x is the acceleration of the structure 1.

In the situation in which no external forces P are acting on the structure 1, that is to say P=0, equation (2) is obtained from equation (1) as follows:

M\ddot{x}+Kx=−c_{T}(x−x_{T}) (2).

This means that, in this case, the structure 1 “sees” the vibration absorber 4 exclusively in the form of a force component −c_{T}(x−x_{T}).

Conversely, equation (3) is applicable to the absorber mass 6:

m_{T}\ddot{x}_{T}−c_{T}(x−x_{T})=0 (3),

where \ddot{x}_{T} is the acceleration of the absorber mass 6. This equation (3) can be converted to the following equation (4):

m_{T}\ddot{x}_{T}+c_{T}x_{T}=c_{T}x (4).

This means that the vibration absorber 4 “sees” exclusively the force component c_{T}x of the structure 1.

The knowledge which can be derived from equations (2) and (4) is implemented in the apparatus 7 according to the invention as shown in FIG. 2. In this case, a vibration sensor 8 is arranged on the structure 1 rather than a mechanical vibration absorber 4, and emits a signal 10 to the control system 9. The control system 9 uses a drive signal 12 to drive an actuator 11, which acts on the structure 1, as a function of the signal 10. The drive signal 12 is in this case proportional to (x−x_{T}), where x is in this case a distance-proportional voltage signal, which the control system 9 generates from the signal 10 from the vibration sensor 9, and x_{T} is in this case a fed-back voltage signal 13 from an electrical resonant circuit 14 in the control system 9. In this way, the control system 9 and the actuator 11 are used to simulate, in analog form, the influence of a vibration absorber on the structure 1. The feedback from the structure 1 to the vibration absorber is in this case simulated via the vibration sensor 9, in which the control system feeds back the distance-proportional voltage signal 15, which is generated from the signal 10 from the vibration sensor 9 and is also included in the drive signal 12, into the electrical resonant circuit 14. The electrical resonant circuit 14 may be designed in various ways. In this case, it is formed by three operational amplifiers, a differential amplifier 16 which amplifies the difference between the voltage signals 13 and 15, and two integrators 17 and 18. In this case, an intermediate signal 19 from the differential amplifier 16 to the integrator 17 corresponds to the acceleration of the absorber mass of a mechanical vibration absorber which is simulated by the resonant circuit 14, while an intermediate signal 20 between the two integrators 17 and 18 corresponds to a velocity of this absorber mass. The fed-back voltage signal 13 is proportional to distance, in the same way as the voltage signal 15. However, while the voltage signal 15 reflects the displacement x of the structure 1, the voltage signal 13 corresponds to the displacement x_{T} of the absorber mass 6. A conditioner 21 in the control system 9 is used to create the distance-proportional voltage signal 15 from the signal 10 from the vibration sensor 8, and to produce the drive signal 12 from the signal 10 and/or the voltage signal 15 and the voltage signal 13. At least when the vibration sensor 8 is a distance sensor and there is no need to integrate the signal 10 in order to generate the voltage signal 15, this relates essentially to level matching between the vibration sensor 8 and the electrical resonant circuit 14 on the one hand, and the electrical resonant circuit 14 and the actuator 11 on the other hand. Except for this level matching, which requires electrical power to be supplied from the outside, the control system 9 operates passively on the basis of the electrical resonant circuit 14. This means that a major proportion of the electrical power for driving the actuator 11 is provided in the form of reactive power by the electrical resonant circuit 14. On this basis, the entire apparatus 7 is highly economic with regard to the electrical power that needs to be supplied to it from the outside.

One advantage of the apparatus 7, which has not yet been mentioned so far, in comparison to the fitting of a mechanical vibration absorber 4 as shown in FIG. 1 to the structure 1 is that the overall control system 9 can be arranged remotely from the structure. As has already been indicated, particularly in the case of relatively high-energy vibrations of the structure 1, the required mass m_{T} of the absorber mass 6 will often be very large for adequate configuration of a vibration absorber 4 as shown in FIG. 1, because the movement distances x_{T} available for the absorber mass 6 are limited in practice. This limitation does not occur with respect to the amplitudes of the voltage signals in the electrical resonant circuit 14. Furthermore, its electrical parameters can be varied, and in particular can be increased, without this influencing the mass of the control system 9 to the same extent as in the case of a mechanical vibration absorber 4 as shown in FIG. 1.

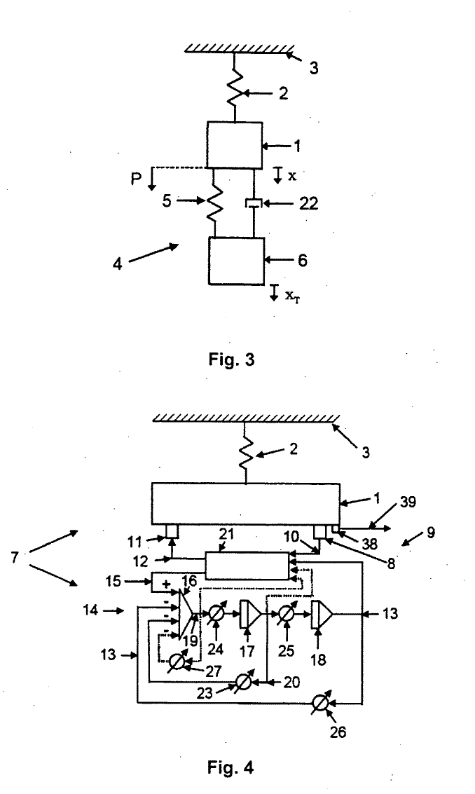

In the case of the system sketched in FIG. 3, a damper 22 is shown, in addition to the absorber stiffness 5, between the structure 1 and the absorber mass 6. The damping of the movement of the absorber mass 6 associated with the damper 22 will frequently not only actually be present, but is invariably desirable. In the case of the apparatus 7 sketched in FIG. 4, this damping is likewise simulated in the control system 9 in that, in the case of the electrical resonant circuit 14, not only the voltage signal 13 but also the intermediate signal 19 between the two integrators 17 and 18 are fed back, with a negative mathematical sign to the differential amplifier 16. This intermediate signal 20 corresponds to a velocity \dot{x}_{T} of the absorber mass of the simulated mechanical vibration absorber. The extent of damping can be adjusted by means of an actuating element 23. Further actuating elements 24 to 26 indicate further capabilities to act on the resonant circuit 14 in order to modify it as required. Furthermore, dashed lines in FIG. 4 indicate that the intermediate signal 19 can also be fed back to the differential amplifier 16 and that, furthermore, the intermediate signals 19 and 20 can also be supplied to the conditioner 21, in order to be included in the drive signal 12. The actuating elements 23 to 26 as well as an actuating element 27 for any intermediate signal 19 that is fed back are in this case in no way restricted to potentiometers for adjustable reduction of the respective input voltage. There may also be adjustable amplifiers or even adjustable inverters for the input voltage. For example, this even allows a negative stiffness or negative damping of a vibration absorber to be simulated in analog form. Finally, FIG. 4 shows an additional vibration sensor 38 on the structure 1, whose signal 39 is used, for example, in order to determine a dominant frequency of the vibrations of the structure 1 in order to tune the natural frequency, or one of the natural frequencies, of the electrical resonant circuit 14 to this. In principle, the signal 10 from the vibration sensor 8 can also be used for this purpose. However, even more vibration sensors can be arranged on the structure 1.

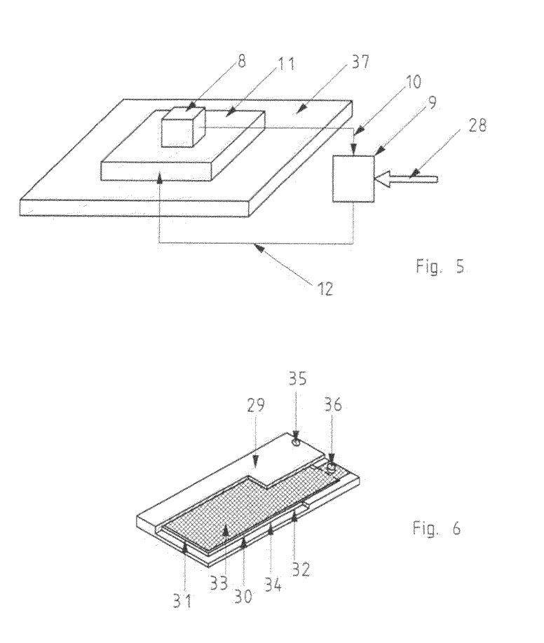

FIG. 5 shows how a flat actuator 11 is arranged on a flat element 28 of the structure 1 by being connected to it over an area. In this case, the control system 9 is shown only as a “Black Box”, which drives the actuator 8 with the drive signal 12 as a function of the signal 10 from the vibration sensor 8 on the structure 1, and is supplied with electrical power 28 from the outside. In this case, the transfer function of the control system 9 between the signal 10 and the drive signal 12 is defined, both in terms of amplitude and phase, by the resonant circuit 14, which is not illustrated here, as shown in FIGS. 2 and 4.

FIG. 6 shows a possible design of the actuator 11. A piezoelectric layer 30 with a two-dimensional extent is arranged in a cover 29, which is used both for electrical insulation and to provide mechanical robustness. The piezoelectric layer 30 is located between two flat electrodes 31 and 32. In this case, the flat electrode 31 is formed by a copper mesh 33, while the flat electrode 32 is a coating 34 on that surface of the piezoelectric layer 20 which faces away from the copper mesh 33. The drive signal 12 is applied between the flat electrodes 31 and 32 via electrical contacts 35 and 36. A voltage between the flat electrodes 31 and 32 results in the piezoelectric layer 30 being extended in its main extent plane, and this extension is transferred to the cover 29. In the arrangement shown in FIG. 5, this extension of the actuator 8 results in curvature of the flat element 28 of the structure 1.

The novel apparatus can be used wherever mechanic vibration absorbers have been used until now. A large number of further applications are also possible by virtue of the variability of its operating point, in which applications no vibration problem occurs or a vibration problem does not just occur at a fixed frequency. One specific application option for the novel apparatus is represented by the reduction of pressure pulsations in a hydraulic line between a pump, which is a frequent cause of pressure pulsations, and a load. In this case, the actuator of the apparatus can act directly on the pulsating hydraulic medium, thus reducing its pressure fluctuations. To this end, a portion of the wall of the hydraulic line, in particular a stiff hydraulic line, in which the pressure pulsations occur, can be formed by the actuator, which is driven orthogonally with respect to the profile of the wall. However, the actuator can also act on the hydraulic line in order primarily to reduce its deformations caused by the pressure pulsations. It therefore also has a reducing effect on the pressure pulsations of the hydraulic medium in the hydraulic line.

### LIST OF REFERENCE SYMBOLS

1 Structure
2 Structure stiffness
3 Base
4 Vibration absorber
5 Absorber stiffness
6 Absorber mass
7 Apparatus
8 Vibration sensor
9 Control system
10 Signal
11 Actuator
12 Drive signal
13 Voltage signal
14 Electrical resonant circuit
15 Voltage signal
16 Differential amplifier
17 Integrator
18 Integrator
19 Intermediate signal
20 Intermediate signal
21 Conditioner
22 Damping
23 Actuating element
24 Actuating element
25 Actuating element
26 Actuating element
27 Actuating element
28 Electrical power
29 Cover
30 Piezoelectric layer
31 flat electrode
32 Flat electrode
33 Copper mesh
34 Surface layer
35 Electrical contact
36 Electrical contact
37 Flat element
38 Sensor
39 Signal

1. An apparatus for reduction of vibrations of a structure, having
a vibration sensor which is arranged on the structure and emits a signal which describes the vibrations,
an actuator which acts on the structure, and
a control system, which drives the actuator as a function of the signal from the vibration sensor and has an electrical resonant circuit with a natural frequency, in which resonant circuit a voltage signal is fed back and which resonant circuit defines a transfer function of the control system between the signal from the vibration sensor and the drive of the actuator,
wherein the control system generates a distance-proportional voltage signal from the signal from the vibration sensor, which voltage signal is proportional to deflections of the structure resulting from the vibrations, and injects this voltage signal into the resonant circuit and
wherein the control system drives the actuator with a difference between the fed-back voltage signal from the electrical resonant circuit and the distance-proportional voltage signal.

2. The apparatus as claimed in claim 1, wherein the natural frequency of the electrical resonant circuit can be varied in order to tune it to a natural frequency of the structure.

3. The apparatus as claimed in claim 1, wherein the electrical resonant circuit is formed from operational amplifiers.

4. The apparatus as claimed in claim 3, wherein the electrical resonant circuit has one differential amplifier and two integrators.

5. The apparatus as claimed in claim 1, wherein the control system dynamically tunes the natural frequency of the electrical resonant circuit as a function of a currently dominant frequency component of the signal from the vibration sensor.

6. The apparatus as claimed in claim 1, wherein the control system dynamically tunes the natural frequency of the electrical resonant circuit as a function of a currently dominant frequency component of a signal, which describes the vibrations, from a further sensor.

7. The apparatus as claimed in claim 1, wherein the control system drives a power amplifier for driving the actuator with the difference between the fed-back voltage signal from the electrical resonant circuit and the distance-proportional voltage signal.

8. The apparatus as claimed in claim 1, wherein the electrical resonant circuit of the control system is in analog form.

9. The apparatus as claimed in claim 1, wherein the electrical resonant circuit of the control system is simulated digitally.

10. The apparatus as claimed in claim 1, wherein the actuator is supported only on the structure.

11. The apparatus as claimed in claim 11, wherein the actuator has a layer structure comprising two flat electrodes and a piezoelectric layer which is arranged between the flat electrodes and extends between the flat electrodes, on their main extent plane, when a voltage is applied.

12. The apparatus as claimed in claim 12, wherein the actuator is connected over an area to a flat element of the structure.

13. The apparatus as claimed in claim 1, wherein the electrical resonant circuit has a plurality of natural frequencies.

14. An apparatus for reduction of vibrations of a structure, having
a vibration sensor which is arranged on the structure and emits a signal which describes the vibrations,
an actuator which acts on the structure, and
a control system, which drives the actuator as a function of the signal from the vibration sensor and has an electrical resonant circuit, which is formed from operational amplifiers and has one natural frequency, in which resonant circuit a voltage signal is fed back, and which resonant circuit defines a transfer function of the control system between the signal from the vibration sensor and the drive of the actuator,
wherein the control system generates a distance-proportional voltage signal from the signal from the vibration sensor, which voltage signal is proportional to deflections of the structure resulting from the vibrations, and injects the voltage signal into the resonant circuit and
wherein the control system drives a power amplifier for driving the actuator with a difference between the fed-back voltage signal from the electrical resonant circuit and the distance-proportional voltage signal.

15. The apparatus as claimed in claim 15, wherein the electrical resonant circuit has one differential amplifier and two integrators.

16. The apparatus as claimed in claim 15, wherein the electrical resonant circuit of the control system is simulated digitally.

17. The apparatus as claimed in claim 17, wherein the electrical resonant circuit has a plurality of natural frequencies.
